(19) United States
(12) Patent Application Publication
(10) Pub. No.: US 2009/0047962 A1
(43) Pub. Date: Feb. 19, 2009

(54) Transfer-of uplink power control parameters during handovers

(76) Inventor: Anil M. Rao, Cedar Knolls, NJ (US)

Correspondence Address: Lucent Technologies Inc.;Docket Administrator- Room 2F-192, 600-700 Mountain Ave., Murray Hill, NJ, 07974-0636, US

(21) Appl. No.: 11/893,029

(22) Filed: Aug. 14, 2007

(51) Int. Cl. H04Q 7/20

(52) U.S. Cl. 455/437

(57) ABSTRACT

The present invention provides a method for performing handover of a mobile unit from a source base station to a target base station. The source base station determines that a mobile unit should be handed over to the target base station. The target base station transmits uplink power control parameters associated with the target base station to the source base station, which transmits them to the mobile unit.

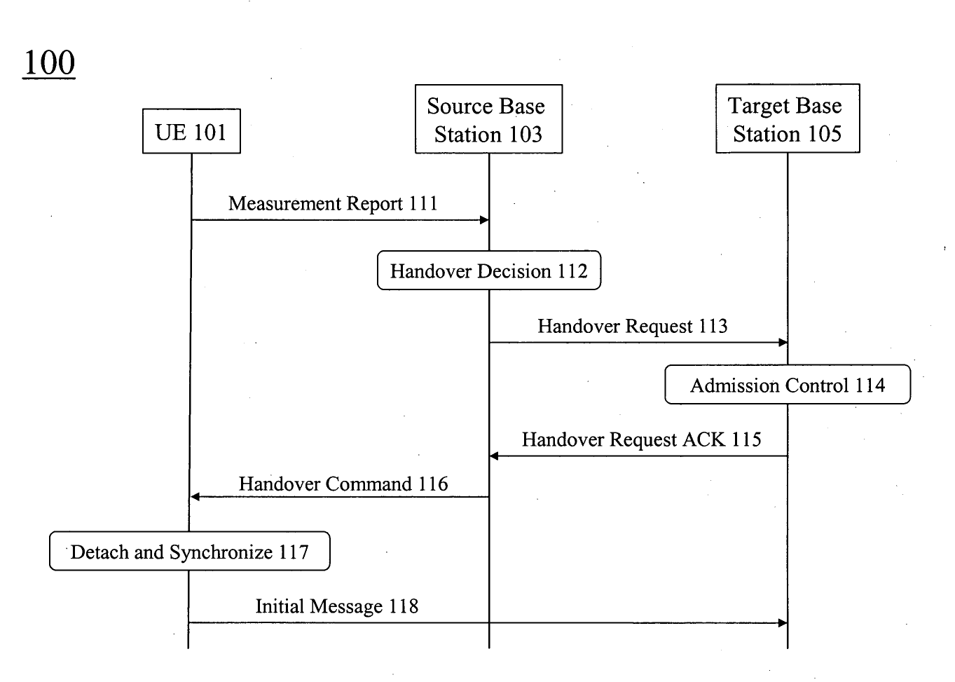

### FIELD OF THE INVENTION

The present invention relates generally to wireless communication systems, and more particularly to handovers in communication systems.

### BACKGROUND OF THE INVENTION

A mobile unit, sometimes referred to as user equipment or a communication unit, can move from the coverage area of a first (source) base station to the coverage area of a second (target) base station. The process of transferring control from the first base station to the second base station is often referred to as handover or handoff.

Although handover allows a mobile unit the ability to travel within, and even outside, of a cellular network, there are problems that arise during handover. Handover problems include delays in the connection between the mobile unit and the second base station and a mobile unit transmitting at an incorrect power level when moving to the target base station.

A first solution of the prior art involves waiting for 40-100 ms to obtain the proper power control parameters from the target base station. However, this causes a loss in throughput and/or dropped packets for latency sensitive applications such as gaming over IP and voice over IP. A second solution is to simply have the mobile unit transmit at the power setting that it was using at the source base station. However, given the potential difference in uplink interference conditions at the different base stations as well as possible differences in uplink power control parameters, the mobile unit will not be transmitting at the proper power level; too high a power level results in excess interference and hence reduced system performance, whereas too low a power level results in quality of service degradation for the user.

Two key features of the LTE (Long Term Evolution) of 3 GPP that are significantly different compared to the legacy UMTS systems are that soft handover is not supported in the uplink and that open loop power control will be used in the uplink. Soft handover not being supported implies that the mobile unit must disconnect from the current serving base station and then reconnect to the target base station and restart its transmission.

Using open link power control in the uplink implies that the mobile unit autonomously adjusts its transmission power in order to achieve a specific target signal to interference plus noise ratio (SINR) at the serving base station.

Therefore in 3 GPP LTE systems a potentially lengthy procedure needs to be performed before the UE is able to transmit at the proper power level after switching from its current serving base station to the target base station.

The consequence of delaying transmission until the proper transmission power can be determined is extra latency, leading to a loss in throughput. For latency sensitive applications like voice over IP (VoIP) or Video Telephony (VT), this extra latency may lead to dropped voice packets, causing unacceptable voice quality during cell switch. It is also possible that the UE simply transmits at the power level it was transmitting with to the source base station even after it switches to the target base station, but this can cause unnecessarily high levels of interference if the power level is too high, or result in quality of service (QoS) degradation if the power level is too low.

Therefore, a need exists for a method of performing handover that does not cause delays in transmission upon handover, dropped voice packets, unacceptable voice quality, or increased levels of interference.

### BRIEF SUMMARY OF THE INVENTION

The present invention provides a solution to the problems of the prior art by transmitting uplink power control parameters to a mobile unit prior to handover completion.

In an exemplary embodiment of the present invention, transfer uplink power control parameters from the target base station are sent to the mobile unit by the source base station during the handover procedure. This allows the mobile unit to have all parameters necessary to immediately begin transmitting at the proper power setting to the new target base station, avoiding the issues of either waiting to obtain the proper power control parameters or transmitting with an incorrect power setting.

The present invention thereby eliminates the need for a mobile unit to wait for power control parameters to be broadcast in the new target base station before transmitting at the proper uplink power level. This saves from 40 ms to 100 ms of delay during handover to a new base station. This allows the mobile unit to transmit at the proper power setting immediately after synchronizing to the new base station, which avoids QoS degradation or generation of excess interference which would be caused by the mobile transmitting with an incorrect power setting or delaying transmission until the power control parameters are available.

### BRIEF DESCRIPTION OF THE SEVERAL VIEWS OF THE DRAWINGS

The figure depicts a message flow between a communication unit, a source base station, and a target base station in accordance with an exemplary embodiment of the present invention.

### DETAILED DESCRIPTION OF THE INVENTION

The figure depicts a message flow 100 between a communication unit, also referred to as a mobile unit or user equipment (UE) 101, a source base station 103, and a target base station 105 in accordance with an exemplary embodiment of the present invention. The figure depicts an exemplary embodiment of the present invention wherein uplink power control settings are transferred from the target base station to the mobile unit via the source base station during the handover procedure. This allows the mobile unit to transmit at the proper power setting immediately after connecting to the target base station, saving 40-100 ms in delay.

UE 101 sends measurement report message 111 to source base station 103. Measurement report message 111 preferably includes parameters that are useful in assisting source base station 103 in deciding if UE 101 should be handed off to another base station. In an exemplary embodiment, measurement report message 111 includes the path loss that UE 101 measures from source base station 103 and the path loss that UE 101 measures from target base station 105. Additionally, measurement report message 111 preferably includes an identification of target base station 105.

Source base station 103 evaluates the measurements sent in measurement report message 111 and decides (112) whether UE 101 should be transferred to target base station 105. This handover decision may, for example, make a handover determination when the path loss between UE 101 and target base station 105 is sufficiently smaller than the path loss between UE 101 and source base station 103. In this example, if the difference in path loss exceeds a predetermined threshold, source base station 103 will make a determination that UE 101 should be handed over to target base station 105.

If source base station 103 determines that a handover of UE 101 to target base station 105 is warranted, source base station 103 sends handover request message 113 to target base station 105. In an exemplary embodiment, handover request message 113 is sent via an X2 interface that preferably connects base stations within the communication network. In an exemplary embodiment, handover request message 113 also includes information relating to the connection of UE 101, such as Quality of Service (QoS) attributes.

Target base station 105 performs admission control (114) to evaluate whether it can support UE 101. In an exemplary embodiment, target base station 105 utilizes current loading and availability of resources at target base station 105 to determine if it will can successfully handle UE 101.

Target base station 105 sends handover request ACK message 115 to source base station 103. If target base station 105 determines that it will accept the handover of UE 101, handover request ACK message 115 includes the uplink power control parameters that it sends in its broadcast message. For example, handover request ACK message 115 preferably includes the uplink interference level at target base station 105 and the target Signal to Interference-plus-Noise Ratio (SINR) at target base station 105.

Source base station 103 sends handover command message 116 to UE 101. Handover command message 116 informs UE 101 to connect to target base station 105 and includes the uplink power control parameters for target base station 105.

UE 101 then detaches from source base station 103 and synchronizes (117) with target base station 105. The synchronization preferably includes a random access procedure with target base station 105. This procedure gets the proper timing for UE 101 in the uplink. In an exemplary embodiment, the synchronization procedure leads to an interruption of transmission on the order of 30 to 40 milliseconds, which is significantly less than the service interruption in the prior art.

UE 101 transmits initial message 118 at the correct power level by using the uplink power control parameters for target base station 105 that UE 101 received in handover command message 116.

While this invention has been described in terms of certain examples thereof, it is not intended that it be limited to the above description, but rather only to the extent set forth in the claims that follow.

I claim:

1. A method for performing handover of a mobile unit from a source base station to a target base station, the method comprising:
initiating a handover request of a mobile unit with a source base station;
transmitting uplink power control parameters associated with a target base station to a source base station prior to completing handover of the mobile unit to the target base station; and
transmitting the uplink power control parameters from the source base station to a mobile unit.

2. A method for performing handover of a mobile unit from a source base station to a target base station in accordance with claim 1, wherein the step of transmitting uplink power control parameters associated with a target base station to a source base station comprises transmitting uplink power control parameters associated with a target base station to a source base station as part of a handover request confirm message.

3. A method for performing handover of a mobile unit from a source base station to a target base station in accordance with claim 1, wherein the step of transmitting the uplink power control parameters from the source base station to a mobile unit comprises transmitting the uplink power control parameters from the source base station to a mobile unit as part of a handover command.

4. A method for performing handover of a mobile unit from a source base station to a target base station in accordance with claim 1, wherein the uplink power control parameters include an uplink interference level at the target base station.

5. A method for performing handover of a mobile unit from a source base station to a target base station in accordance with claim 1, wherein the uplink power control parameters include a target signal to interference plus noise ratio (SINR) at the target base station.

6. A method for performing handover of a mobile unit from a source base station to a target base station in accordance with claim 1, wherein the uplink power control parameters include a fractional power control parameters at the target base station.

7. A method for performing handover of a mobile unit from a source base station to a target base station in accordance with claim 1, the method further comprising the step of transmitting a path loss measurement between the mobile unit and the target base station from the mobile unit.

8. A method for performing handover of a mobile unit from a source base station to a target base station in accordance with claim 7, further comprising the step of utilizing the path loss measurement when transmitting between the mobile unit and the target base station.

9. A method for performing handover of a mobile unit from a source base station to a target base station in accordance with claim 1, the method further comprising the step of transmitting from the mobile unit to the target base station using the uplink power control parameters.

10. A method for performing handover of a mobile unit from a source base station to a target base station in accordance with claim 1, the method further comprising the step of transmitting from the mobile unit to the target base station using the uplink power control parameters and a path loss measurement between the mobile unit and the target base station.

11. A method for performing handover of a mobile unit from a source base station to a target base station, the method comprising:
determining a first path loss between a mobile unit and a source base station;
determining a second path loss between the mobile unit and a target base station; and
initiating a handover request of the mobile unit when the first path loss is greater than the second path loss.

12. A method for performing handover of a mobile unit from a source base station to a target base station in accordance with claim 11, the method further comprising the step of transmitting uplink power control parameters associated with the target base station to the source base station prior to completing handover of the mobile unit to the target base station.

13. A method for performing handover of a mobile unit from a source base station to a target base station in accordance with claim 12, the method further comprising the step of transmitting the uplink power control parameters from the source base station to the mobile unit.
